(19) United States
(12) Patent Application Publication
(10) Pub. No.: US 2005/0268408 A1
(43) Pub. Date: Dec. 8, 2005

(54) Cleaning system

(75) Inventor: Chien-Hung Chin, Taipei Hsein (TW)

Correspondence Address: BRUCE H. TROXELL;SUITE 1404, 5205 LEESBURG PIKE, FALLS CHURCH, VA, 22041, US

(73) Assignee: AU Optronics Corp.

(21) Appl. No.: 11/143,675

(22) Filed: Jun. 3, 2005

(30) Foreign Application Priority Data
Jun. 4, 2004 (TW) 93116155

(51) Int. Cl. B08B 11/00

(52) U.S. Cl. 15/1.51; 15/301; 15/309.2

(57) ABSTRACT

A cleaning system comprises a chamber and a particle-removing device. The particle-removing device, arranged outside the chamber, including an ionizer ionizing surrounding gas and spouting the ionized gas and a vacuum unit. Whereby, before an substrate is sent into the chamber, the ionized gas spouted from the ionizer neutralizes electrostatic charges and blowing up particles accumulate on the substrate and the particles are drawn away by the vacuum unit so that the object can be transmitted into the chamber much cleaner.

### BACKGROUND OF THE INVENTION

(1) Field of the Invention

The invention relates to a cleaning system and more particularly to the cleaning system that utilizes ionized gas to clean an object thereinside.

(2) Description of the Prior Art

In manufacturing a liquid crystal display (LCD), it is always an important issue to keep the glass substrate clean and to avoid the particles, which are the major sources of pollution, to contaminate the substrate.

For example, the circuit pattern on a glass substrate of the LCD is formed by repeatedly performing photo engraving processes on a glass substrate. Typically, the process is performed by plastering the photoresist on the surface of the silicon film of the glass substrate, exposing the photoresist of the glass substrate through a photo mask with a predetermined circuit pattern, developing the hardened sensitized photoresist to remove the undesired part of the photoresist and finally forming the circuit pattern on the surface of the silicon film of the glass substrate by etching.

If particles exist around the area to be etched before a practical etching begins, then the particles there may act as a hard mask thereafter that prevents the area under the particles from being etched. It impacts the following process and may cause the defects in the product. Obviously, such a hard mask formed by accumulating unexpected particles jeopardize the manufacturing of the LCD.

Generally, the particles come from the environment, such as operators, working machines or floating dusts in the air. Various causes may make particles to adhere to the surface of the substrate. Some of them are listed as follows:
1. The particles floating in the environment drop onto the surface due to the gravity.
2. Attraction (ex: Van der Waals forces) between the particles and the molecules of the silicon film may grasp the particles to settle on the silicon film.
3. Electrostatic force between the surface of the glass substrate and the charged particles may drive the particles to hit on the surface of the glass substrate.

Thus, in practice, after a developing process upon the substrate is completed, the etching process has to be executed within a limited time so that the time for the glass substrate to be exposed to the environment can be reduced and thus the degree of the particles adhering to the substrate can be minimized.

Moreover, before the etching, various kinds of methods can be utilized to remove the particles, such as the wet cleaning by a supersonic means with a pure water or cleaning liquid, the dry cleaning by a spouting means with a clean gas to blow the particles on the substrate's surface away, and so on. However, since the wet cleaning has the risk to leave the mist on the surface of the glass substrate so as to incomplete the etching, thus the dry cleaning is preferable to be adopted as the pre-cleaning before the etching process.

In FIG. 1, an etching machine 1 for carrying out a typical etching operation is illustrated. The etching machine 1 is used to etch a glass substrate 10 which has already been coated with photoresist. The etching machine 1 provides a central transmitting chamber 11 having a mechanical arm 12 thereinside. The central transmitting chamber 11 is surrounded by a stocker chamber 13, a cleaning chamber 15 and several etching chambers 14 (four shown in the figure). The mechanical arm 12 is used to transmit the glass substrates 10 among the stocker chamber 13, the cleaning chamber 15, and the etching chambers 14.

The stocker chamber 13 is the entrance of the etching machine 1. The glass substrate 10 is sent to the stocker chamber 13 firstly and transmitted to the cleaning chamber 15 from the stocker chamber 13 for cleaning by the mechanical arm 12. After the cleaning process, the substrate 10 is sent to the etching chamber 14 for etching.

The cleaning chamber 15 usually provides a dry-cleaning machine, which is usually sized to meet the size of the glass substrate. As the substrate 10 is moved into the cleaning chamber 15, the dry-cleaning machine thereinside will generate an air knife (a high-pressure flow) to blow over the surface of the substrate 10 at a short distance so as to remove the particles deposited on the surface.

Nevertheless, there are still following shortcomings in the aforesaid cleaning:
1. Before the substrate is sent into the etching chamber 14, a substantial period of time is needed for the substrate to stay in the cleaning chamber and to transmit among the chambers. This will extend the etching process.
2. The dry-cleaning machine occupies the limited space in the etching machine, such that only a small number of the etching chambers that can be equipped therewith.
3. If the particles lifted by the air knife are not taken away, they may again stick on the cleared area in the etching machine. This will decrease the cleaning efficiency.
4. The direct high-pressure flow to the glass surface may contribute to the static charge accumulation on the glass surface. As a result, those particles are hard to remove due to the electrostatic force. Beside the cleaning efficiency may be reduced, the induced electrostatic discharging may also break down the circuit components.

Accordingly, any effort devoted to improving the cleaning techniques upon the manufacturing of LCD so as to promote the yield is definitely welcome to all the persons in the art.

### SUMMARY OF THE INVENTION

One object of the present invention is to provide a cleaning system that can substantially reduce the cleaning time of the substrate prior to an etching process.

Another object of the present invention is to provide a cleaning system that make a better arrangement of the available working space inside the machine.

The other object of the present invention is to provide a cleaning system that can integrate different cleaning means for achieving a better cleaning efficiency.

Moreover, one object of the present invention can also be to provide a cleaning system that can prevent the static charges accumulation on an object.

For those purposes, the present invention combines of a particle-removing device with a chamber. Before an object or a substrate is sent into the chamber for reaction, the particle-removing device can clean the object by blowing an ionized gas to drive away particles on the surface of the object and, at the same time, vacuum the lifted particles so that they won't stick back on the surface of the object.

In the present invention, the cleaning system comprises a chamber and a particle-removing device. The particle-removing device, arranged outside the chamber, including an ionizer ionizing surrounding gas and spouting the ionized gas and a vacuum unit.

The ionizer may have several sharp electrodes for providing high voltages. The electric field at the tip of the electrode can be increased to ionize the surrounding gas and the ionized gas is then spouted out through the nozzle. The ionizer is connected to a gas piping for providing a pressurized clean dry air or nitrogen to the ionizer. The vacuum unit can connect with a vacuum piping to draw the particles in.

While an object is sent into the chamber, the ionizer spouts the ionized gas on the object's surface at an appropriate angle, temperature and pressure through the nozzle of the ionizer. In the present invention, the ionized gas from ionizer can neutralize the accumulated static charges on the surface and remove the electrostatic force, as well as the residual mist. Since the particles on the object's surface are disturbed, the vacuum unit will draw in the particles away so as not to have the particles stick back on the surface of the object.

Moreover, this cleaning system can utilize a mechanical arm for carrying the object at a control speed to pass through the ionizer and the vacuum unit. Particle removing is completed during the object passing through the ionizer and the vacuum unit before the object is moved into the chamber for reaction.

To make the essence of this invention clear, we have details with figures as follows.

### BRIEF DESCRIPTION OF THE DRAWINGS

The present invention will now be specified with reference to its preferred embodiment illustrated in the drawings, in which:

FIG. 1 is a schematic diagram of a conventional etching machine for carrying out a typical etching operation;

FIG. 2A is a perspective view of a preferred cleaning system according to the present invention;

FIG. 2B is a schematic diagram to show an action of the particle-removing device of FIG. 2A;

FIG. 3 is a schematic diagram of a first embodiment of the etching machine according to the present invention; and

FIG. 4 is a schematic diagram of a second embodiment of the etching machine according to the present invention.

### DESCRIPTION OF THE PREFERRED EMBODIMENTS

The invention disclosed herein is directed to a cleaning system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

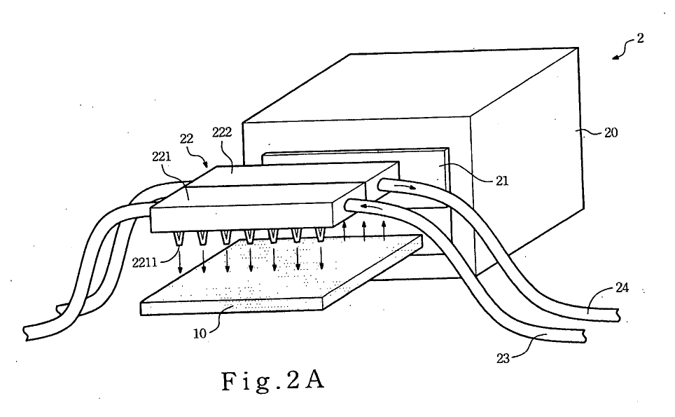

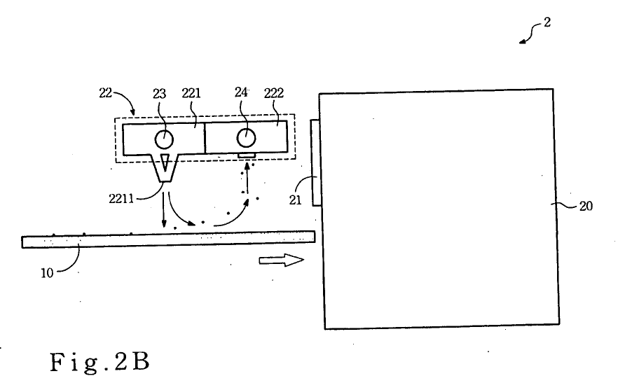

Referring to FIG. 2A, a preferred cleaning system in accordance with the present invention is structured as shown. The cleaning system 2, can be disposed in an etching machine for etching glass substrates 10 coated with photoresist.

Referring to FIG. 2B, it is a schematic diagram to show an action of the particle-removing device of FIG. 2A. As shown, the cleaning system 2 comprises a chamber 20, a gate 21, a particle-removing device 22, a gas piping 23 and a vacuum piping 24. The gate 21 forms an entrance of the chamber 20. The particle-removing device 22 is arranged outside the chamber and near the gate 21. The particle-removing device 22 comprises an ionizer 221 and a vacuum unit 222 is disposed in front of the gate 21, in which the vacuum unit 222 is positioned closer to the gate 21 than the ionizer 221.

The ionizer 221 has several sharp electrodes provided with high voltages so as to generate an electric field around each tip of the electrode and further has a nozzle 2211. It is noted that, as the voltage of the electrode is increased to a critical level, ionized gas around the electrode will attain a saturation state and spout out through the nozzle 2211. The ionizer 221 is connected to the gas piping 23 for providing dry clean pressurized air to the ionizer 221. The pressurized air will flow through the nozzle 2211, thus mixing the ionized gas, to strike on the substrate 10 located thereunder and disturb particles on the substrate 10. The vacuum unit 222 is connected to the vacuum piping 25 for drawing the particles lifted or disturbed by the ionizer 221.

In operation, the glass substrate 10 passes under the particle-removing device 22 before being sent into the chamber 20 through the gate 21. The ionizer 221 can spout the ionized gas onto the surface of the glass substrate 10 at an appropriate angle, temperature and pressure through the nozzle 2211. Beside neutralizing static charges accumulated on the glass substrate 10, the device can also remove possible local electrostatic fields and residual mists thereon. The vacuum unit 222 will suck in the particles lifted by the ionizer 221 so as to ensure the particles not to stick back on the surface of the object again.

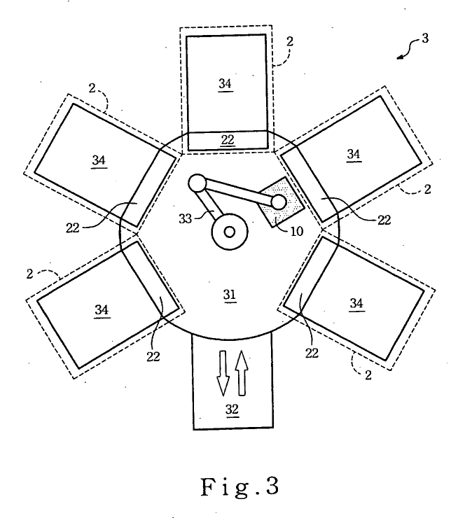

FIG. 3 is a schematic diagram of a preferred etching machine 3 in accordance with the present invention. The etching machine 3 comprises a transmitting chamber 31, a stocker chamber 32, a first mechanical arm 33 and a plurality of etching chambers 34.

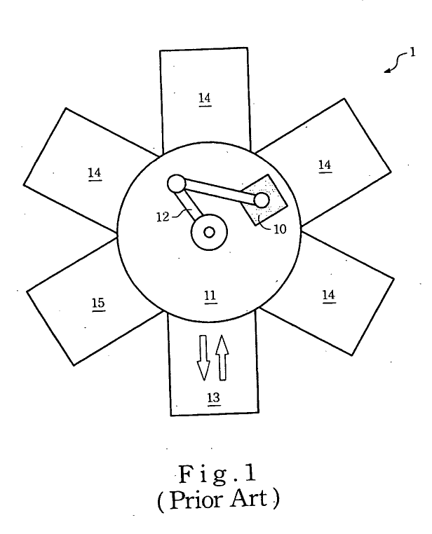

The differences between the etching machine 3 shown in FIG. 3 and the conventional machine shown in FIG. 1 are that there are a plurality of the cleaning systems 2 described in FIGS. 2A and 2B applied in the etching machine 3. Since the cleaning systems 2 are applied in the etching machine 3, an additional dry-cleaning machine is no more needed to remove the particles on the surface of the glass substrate. Therefore, the place for installing the cleaning room 15 of FIG. 1 can be kept to mount an additional etching machine.

In this embodiment, the chamber of the cleaning system 2 is a etching chambers 34. During the mechanical arm 33 carries the glass substrate 10 to the etching chamber 34 at an appropriate speed via passing the particle-removing device 22, static charges accumulated on the surface of the substrate can be removed in the way as described above.

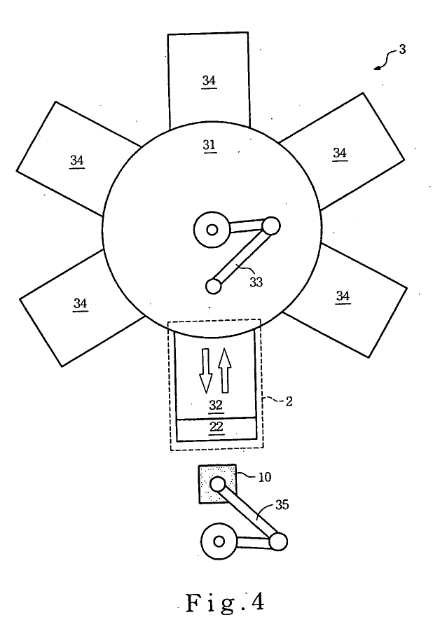

As shown in FIG. 4, the chamber of the cleaning system 2 in the second embodiment of the etching machine 3 can be a stocker chamber 32. The difference to the first embodiment is that, in this second embodiment, while the glass substrate 10 is sent through the stocker chamber 32 at an appropriate speed by a second mechanical arm 35, the particle-removing device 22 in the chamber 32 can neutralize the static charges accumulated on the surface of the substrate 10 in the way as described above, and can also lift and sweep away the particles on the surface of the substrate 10. After the surface of the glass substrate 10 is cleaned, the glass substrate 10 is sent into a latter part of the stocker chamber 32 and then carried out of the stocker chamber 32 by the first mechanical arm 33 for further reaction in the etching machine 3.

It is clear that the invented process chamber having the cleaning function has various advantages at least as follows:
1. The cleaning step of the conventional design before the substrate is sent into the process chamber for etching is omitted in the present invention, such that the operation time of an etching process in the invented etching machine can be reduced.
2. The combination of the particle-removing device and the process chamber can save the space used to be occupied by the cleaning device.
3. By integrating cleaning steps of spouting the ionized gas onto the glass substrate for blowing up the particles by means of the ionizer, neutralizing the charges, and drawing the lifted particles, the particles on the substrate can be removed simultaneously, more easily and effectively
4. Neutralizing the static charges accumulated on the surface of the glass substrate by means of the ionic flow solves the inherent problem of components being damaged by electrostatic discharging on the substrate.

The embodiment above is to illustrate the invention in detail but not to give a specific embodiment. Any modification that doesn't exceed the essence of the invention should belong to this invention. Thus the invention should be safeguarded according to the claims as follows.

While the present invention has been particularly shown and described with reference to a preferred embodiment, it will be understood by those skilled in the art that various changes in form and detail may be without departing from the spirit and scope of the present invention.

1. A cleaning system, comprising:
a chamber; and
a particle-removing device, arranged outside the chamber, including an ionizer ionizing surrounding gas and spouting the ionized gas and a vacuum unit;
whereby, before an substrate is sent into the chamber, the ionized gas spouted from the ionizer neutralizes electrostatic charges and blowing up particles accumulated on the substrate, and the particles are drawn away by the vacuum unit.

2. The cleaning system according to claim 1, wherein said ionizer is connected to a gas piping for providing a pressurized gas.

3. The cleaning system according to claim 2, wherein said pressurized gas is dry clean air.

4. The cleaning system according to claim 2, wherein said pressurized gas is nitrogen.

5. The cleaning system according to claim 1, wherein said vacuum unit is connected to a vacuum piping.
